(19) United States
(12) Patent Application Publication
(10) Pub. No.: US 2017/0306830 A1
(43) Pub. Date: Oct. 26, 2017

(54) Internal Combustion Engine for an Outboard Motor

(71) Applicant: Neander Motors AG, Kiel (DE)

(72) Inventors: Claus BRUESTLE, Nordheim (DE); Richard DAVIS, Mequon, WI (US)

(21) Appl. No.: 15/491,348

(22) Filed: Apr. 19, 2017

(30) Foreign Application Priority Data
Apr. 20, 2016 (DE) 10 2016 004 763.1

(51) Int. Cl. F01P 1/06; F02M 35/16; F02M 35/10; F02B 75/06; F01P 5/04; F02B 75/00; F02B 61/04; F04D 29/26

(52) U.S. Cl. CPC F01P 1/06; F04D 29/26; F02M 35/167; F02M 35/10262; F02M 35/10157; F01P 5/04; F02B 75/007; F02B 61/045; F02B 75/06; F01P 2050/12

(57) ABSTRACT

An internal combustion engine for an outboard motor for driving a vessel has an air guide system acting by way of a covering hood surrounding surfaces of the internal combustion engine and ancillary units. Covering hood inlet and outlet openings permit airflows to move in an interior space of the covering hood, and a fan driven by the internal combustion engine influences the airflows in the covering hood interior space. Airflows enter the interior space of the covering hood via an inlet opening and a first routing arrangement. Assisted by the fan, part of the airflows acts on the surfaces of the internal combustion engine and of the ancillary units. A second routing arrangement routs another portion of the airflows, as intake air, to an engine suction system. Airflows heated by engine and ancillary unit surfaces are conveyed by the fan and a third routing arrangement outside the covering hood.

### CROSS REFERENCE TO RELATED APPLICATIONS

This application claims priority under 35 U.S.C. §119 from German Patent Application No. 10 2016 004 763.1, filed Apr. 20, 2016, the entire disclosure of which is herein expressly incorporated by reference.

### BACKGROUND AND SUMMARY OF THE INVENTION

The present invention relates to an internal combustion engine for an outboard motor having an air guide system.

An internal combustion engine known from U.S. Pat. No. 6,302,749 B1 operates as an outboard motor for driving a watercraft. The internal combustion engine is surrounded by a covering hood, which delimits an interior space. For the purpose of taking air into and exhausting air from the interior space, intake and outlet means are provided, on the covering hood that extensively encases the internal combustion engine, for airflows moving in the interior space that serve to act on housing surfaces of the internal combustion engine. The internal combustion engine comprises an upright crankshaft, which acts in combination with a plurality of pistons and which, at an upper end region, drives balancer shafts by means of an endless drive. An alternator having an upright rotation axis is provided with a fan, which takes air into and exhausts air from the interior space of a hood-type endless-drive cover.

German Document DE 102 05 109 B4 discloses an outboard motor provided with a vertically oriented crankshaft and a plurality of ancillary units attached to an outer side of an engine housing of the outboard motor. A covering hood encases the outboard motor, or the ancillary units. Air inlet slots, which act in combination with an adjoining air routing device, are provided on a rear side of the covering hood. The function of the air routing device is to route fresh air into an upper region and a lower region of the interior space of the covering hood, or onto the engine housing and onto the ancillary units.

The object of the invention is to design an internal combustion engine for an outboard motor for driving a vessel, in which an air guide system that serves and sets standards in respect of the supplying of cooling air and intake air for the internal combustion engine is provided in the interior space of a covering hood that surrounds the internal combustion engine. It is also to be ensured that the air guide system can be realized at reasonable cost.

This object is achieved according to the invention claimed. Further features of the invention are set out as well in the claims.

The main advantages achieved by the invention are that the air guide system, which in combination with the internal combustion engine of the outboard motor that is encased by means of the covering hood, is distinguished by exemplary functioning and ease of realization. Thus, by means of the air guide system in the interior space of the covering hood provided with the inlet and outlet openings, and with the assistance of the fan, the airflows in the interior space are selectively controlled. In this case, the airflows entering via the inlet openings are deflected into the interior space, in a manner that supports the system, with the aid of the first, easily realizable routing means. To effect exemplary cooling, a portion of these airflows acts on the surfaces of the housing of the internal combustion engine and the ancillary units thereof. And another portion of the airflows is supplied to the suction system via a simple second routing means. Moreover, the air guide system ensures that the airflows ingeniously cool the surfaces of the internal combustion engine, or of the ancillary units attached thereto. In other words, the airflows are ingeniously aspirated by the fan and pass, as exhaust air, via the outlet opening, into the atmosphere. The inlet opening is easily realized in the central longitudinal plane of the outboard motor, this being at the upper end region of the rear upright hood wall of the covering hood, wherein the first routing means extends from the inlet opening in the direction of a lower side of the internal combustion engine, and has a flow-over region toward the interior space. It is to be emphasized that the routing means is constituted by a hood portion of the upright hood wall and an inner wall, which hood wall and inner wall constitute a kind of channel.

A pioneering solution of the ventilation system is that the fan is driven by means of an upright crankshaft of the internal combustion engine that projects in an upright manner over the upper side of the internal combustion engine. In respect of function, it is appropriate that, as viewed in the direction of travel of the vessel, the inlet opening is disposed on the rear hood wall, and the fan is disposed adjacently to a front hood wall of the covering hood, having the desired effect that the airflows sweep past the surfaces, removing heat. It is useful that the crankshaft that drives the fan, together with another crankshaft that is parallel to the latter, constitutes a crankshaft system of the internal combustion engine, in which the crankshafts are operatively connected, via two connecting rods, to at least one reciprocating piston. This design is optimizing in effect if the crankshafts disposed transversely in relation to the direction of travel have, at their upper ends that project over the end wall of the internal combustion engine, first and second flywheels, which, as viewed in the vertical direction of the crankshafts, are disposed in an offset manner in relation to one other and overlap one another, wherein the fan is integral with the first upper flywheel, which, besides its function as a store of rotational energy, also additionally acts as a drive means for the fan.

An advantage is offered by the technical solution in which the upper flywheel, with the fan, and the second, lower flywheel are encased by means of an upper hood portion and a lower hood portion, which are realized as a fan-flywheel cover that is produced from one piece or composed of a plurality of parts. Also particularly well conceived is the fact that the first cylindrical hood portion encasing the fan is provided with the third routing means, which, via a spiral-type tangential portion, routes the exhaust air conveyed by the fan, via the outlet opening, into the atmosphere. In addition, the lower hood portion has one or more through-openings, e.g. in the form of exhaust-air slots, on a horizontal covering wall. Good functioning of the fan is achieved if it comprises a fan wheel system having mixed flow, radial flow, or the like.

It is structurally and functionally ingenious that the second routing means toward the suction system of the internal combustion engine comprises a tube element, which extends between the lower side of the interior space of the covering hood and the suction system located on an upper side of the internal combustion engine. This is assisted in that the second routing means, realized as a tube element, is connected to a compressor, of an exhaust-gas turbocharging means of the internal combustion engine, that is connected to the suction system, and that a tube portion extending adjacently to the lower side of the interior space of the covering hood is provided with at least one inlet opening.

Finally, the method for operating the air guide system in the interior space of the covering hood of the outboard motor is an ingenious solution because it is distinguished by a high degree of efficiency, owing to inlet and outlet openings in the covering hood, the routing means applied in an operatively appropriate manner, and the fan on the flywheel.

### BRIEF DESCRIPTION OF THE DRAWINGS

The drawings show an exemplary embodiment of the invention, which is described in greater detail in the following. Other objects, advantages and novel features of the present invention will become apparent from the following detailed description of one or more preferred embodiments when considered in conjunction with the accompanying drawings.

FIG. 1 is a schematic side view of an outboard motor, with an internal combustion engine, a covering hood, and an air guide system.

FIG. 2 is a schematic top view of a crankshaft system of the internal combustion engine.

FIG. 3 is a side view of the outboard motor, in partial section.

FIG. 4 is an oblique view of the internal combustion engine from the top, with details of the air guide system according to FIG. 1 shown.

FIG. 5 is an oblique, top frontal view of the fan-flywheel cover.

FIG. 6 is an oblique top view of the internal combustion engine, from the rear, with a routing means for intake air and the fan-flywheel cover according to FIG. 4.

FIG. 7 is an oblique view from the rear of the internal combustion engine, with routing means and fan-flywheel cover shown.

FIG. 8 is an oblique view of the covering hood of the outboard motor, from the rear.

### DETAILED DESCRIPTION OF THE DRAWINGS

An outboard motor 1 is for driving a vessel, not represented in greater detail, in water. The outboard motor 1 comprises an internal combustion engine 2, which, as viewed in the direction of travel A of the vessel, has a back side 3, a front side 4, and, as viewed in the vertical direction B-B, an upper side 5, and a lower side 6. In addition, the internal combustion engine 2 is delimited by a left longitudinal side 7 and a right longitudinal side 8. A plurality of ancillary units, e.g. units 9, 10, and 11—FIG. 3—which are not explained in greater detail, are mounted on the longitudinal sides 7 and 8.

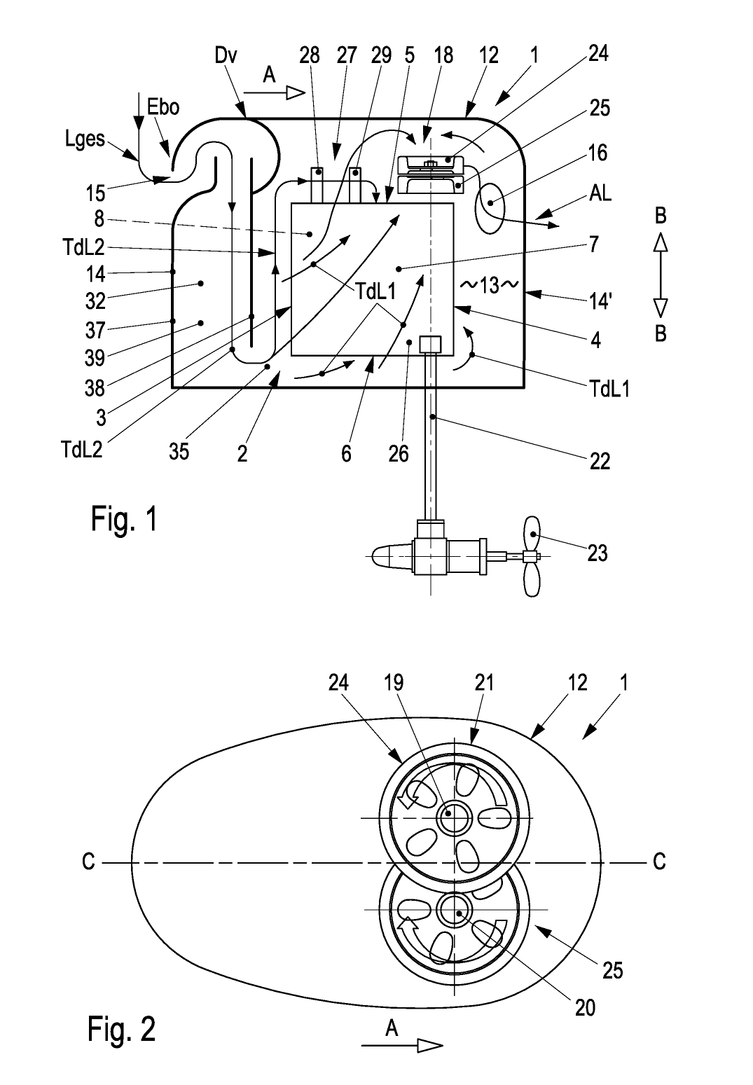

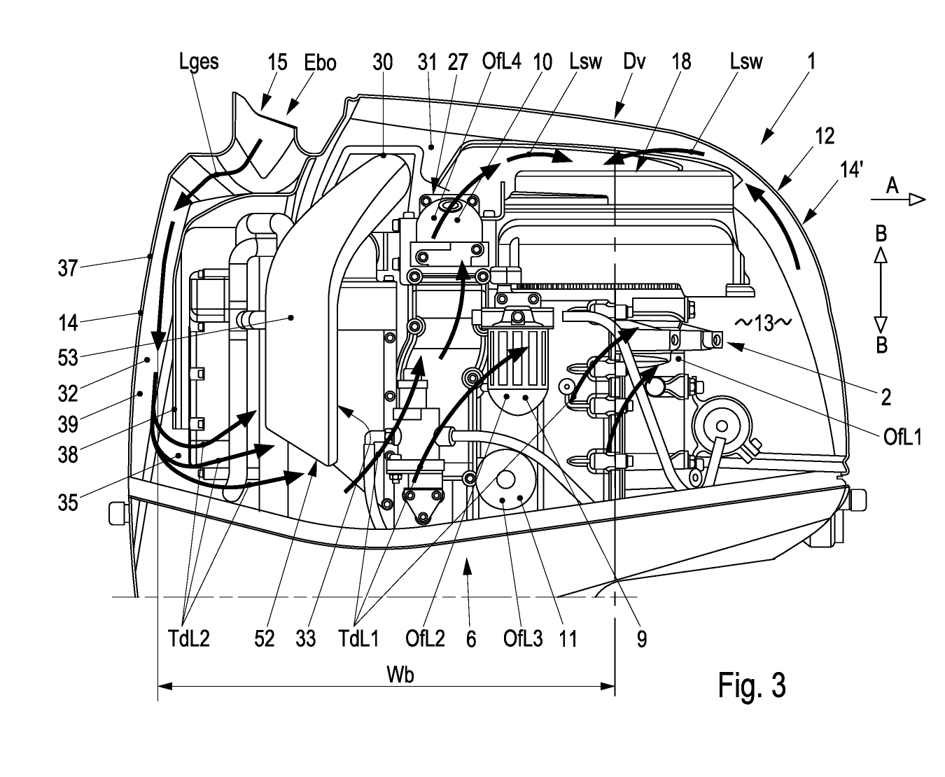

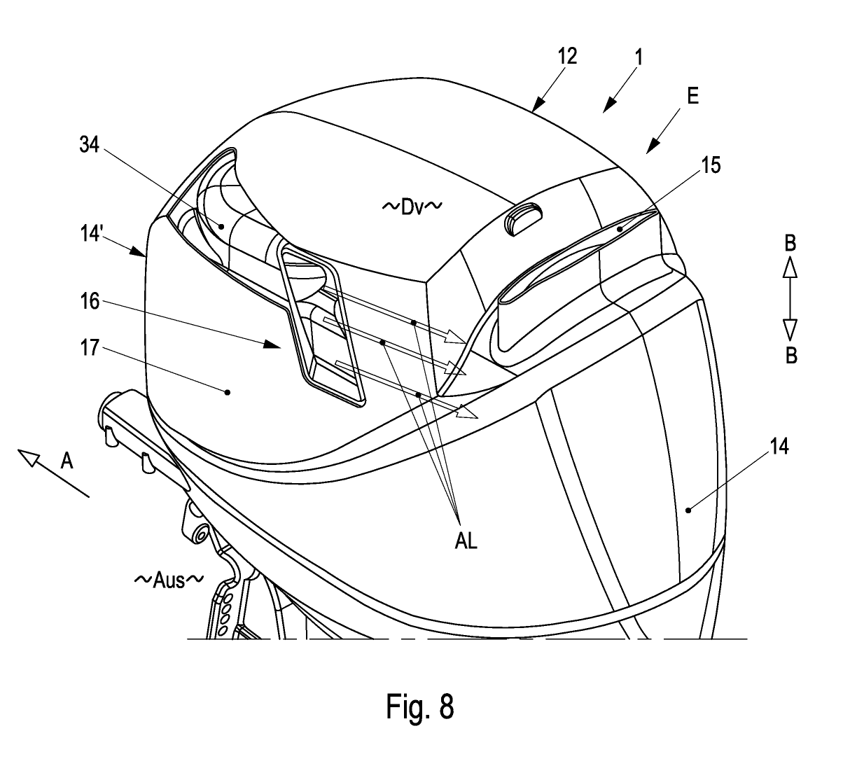

A covering hood 12 surrounds the internal combustion engine 2, with its ancillary units 9, 10, and 11, or the surfaces thereof, and forms an interior space 13. Arranged on an upright, first rear hood wall 14 of the covering hood 12 that is adjacent to the back side 3 there is an inlet opening 15, via which complete airflows Lges flow into the interior space 13 of the covering hood 12. For this purpose, the latter additionally has an outlet opening 16—FIGS. 1 and 8—for exhaust air flows AL, which is made in an upright, left lateral hood wall 17, this being at a defined distance from the rear hood wall 14. A fan 18—FIGS. 1, 3 and 4—which is disposed on the upper side 5 of the internal combustion engine 2 and which is driven by the latter, serves to move the airflows Lges. A front hood wall is denoted by the reference 14′—FIGS. 1 and 2.

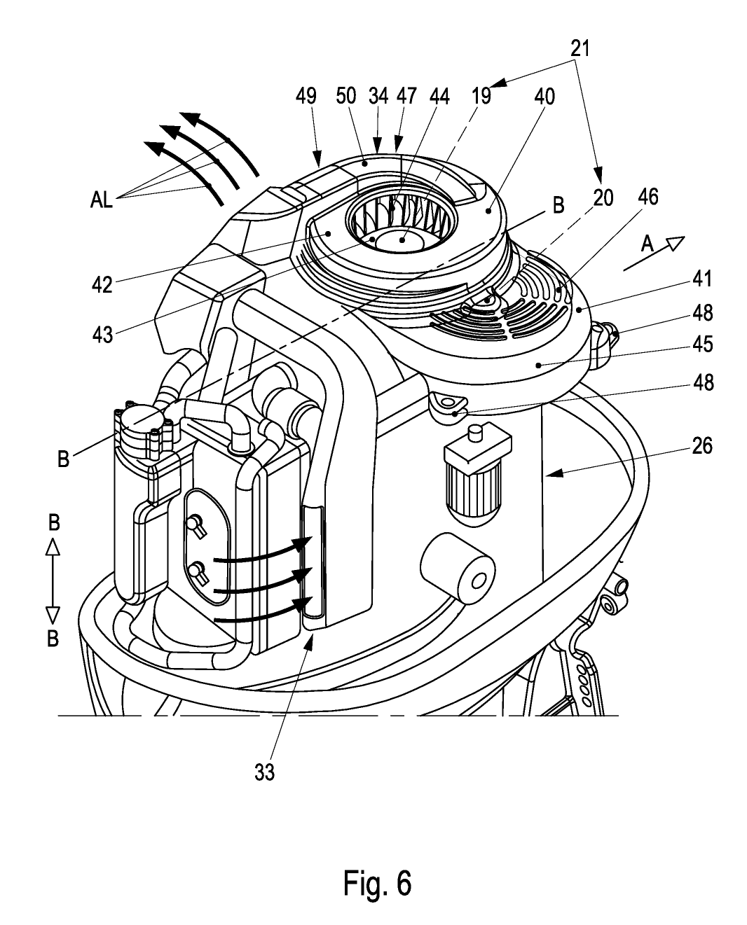

The internal combustion engine 2, which is of a reciprocating piston type, has at least one reciprocating piston that, via two connecting rods, is operatively connected to first and second, crankshafts 19 and 20, which are oriented parallel to each other, and which rotate in opposite directions of rotation. The first and second crankshafts 19 and 20 of a crankshaft system 21—FIGS. 2 and 6—stand relatively upright in relation to a waterline of the vessel, not represented, and drive a boat propeller 23—FIG. 1—below the waterline, by means of a drive shaft 22. The crankshafts 19 and 20 project beyond the upper side 5 of the internal combustion engine 2, are located next to each other, symmetrically in relation to a central longitudinal plane C-C—FIG. 2—of the internal combustion engine 2, transversely in relation to the direction of travel A, and the crankshafts are provided, at end regions, with first and second flywheels 24 and 25, FIGS. 1 and 2. As viewed in the vertical direction B-B, the first flywheel 24 and the second flywheel 25 are attached, offset in relation to each other, to the crankshafts 19 and 20, and overlap mutually in regions for reasons of space saving. The first flywheel 24 is located above the second flywheel 25, and the first flywheel 24 carries the fan 18—FIG. 1.

By means of a housing 26, the internal combustion engine 2 accommodates the crankshafts 19 and 20, and the internal combustion engine 2 operates according to a diesel injection method, wherein, for the purpose of optimizing the operation thereof, an exhaust-gas turbocharging means 27 is provided, having a compressor 28 and an exhaust-gas turbine 29. The exhaust-gas turbocharging means 27 is connected to a suction system 30 of the internal combustion engine 2, which exhaust-gas turbocharging means 27 and suction system 30 are disposed on the upper side 5 of the internal combustion engine 2, being thus disposed not far from the rear hood wall 14 of the covering hood 12. Further details of the internal combustion engine 2 are available from European publication EP 2 980 374 A1, which deals with a similar internal combustion engine.

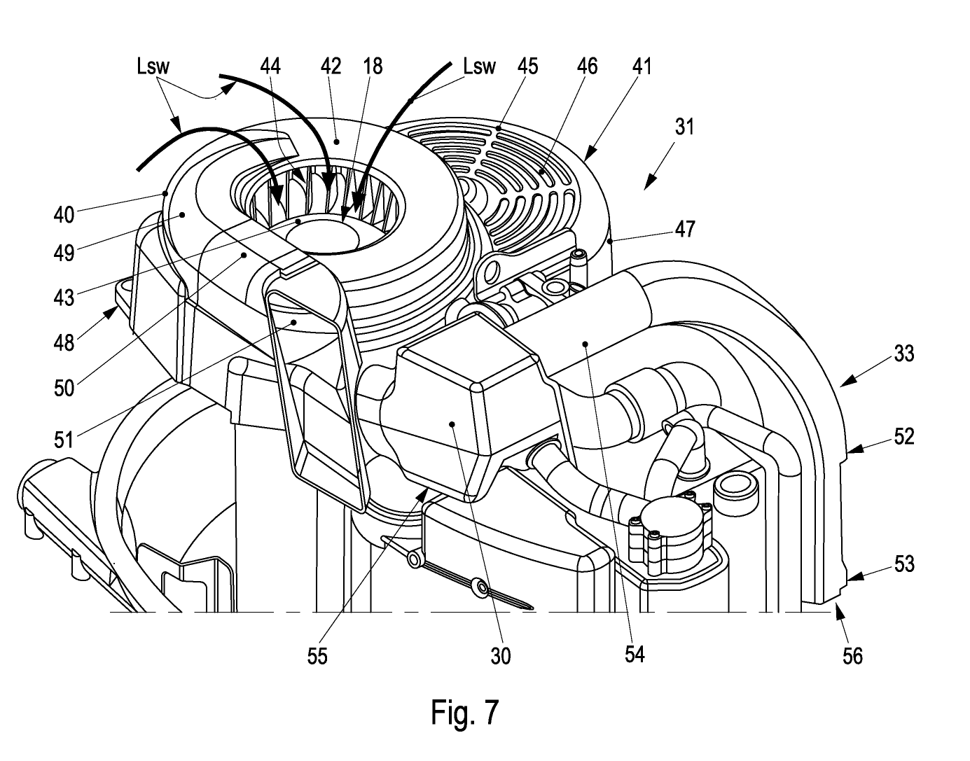

Together with the inlet opening 15, the outlet opening 16 and the fan 18, there is an air guide system 31 acting in the interior space 13 of the covering hood 12. In this case, the complete airflows Lges entering via the inlet opening 15 go into a first routing means or arrangement 32, which adjoins this inlet opening 15 and from which, assisted by the fan 18, a first portion of the airflows TdL1 acts on operationally heated surfaces, e.g. OfL1, OfL2, OfL3 and OfL4 of the internal combustion engine 2, or ancillary units 9, 10 and 11. By means of a second routing means or arrangement 33, another, second, portion of the airflows TdL2 reaches the suction system 30 of the internal combustion engine 2 as intake air. Airflows Lsw—FIGS. 3 and 7—heated by the surfaces OfL1 to OfL4 of the internal combustion engine 2, or of the ancillary units 9, 10, 11, are conveyed by the fan 18 and a third routing means or arrangement 34, as exhaust air AL, via the outlet opening 16 in the hood wall 17 of the cover 12, to the outside Aus of the latter, or into the atmosphere.

The inlet opening 15 is disposed at an upper end region Ebo, adjacent to an upper top casing of the hood wall 14, and the first routing means 32 extends in an upright manner from the inlet opening 15 in the direction of the lower side 6 of the internal combustion engine 2. Adjacent to this lower side 6, the routing means 32 has a flow-over region 35—FIGS. 1 and 3—toward the interior space 13. The first routing means 32 is constituted by a hood wall portion 37 of the hood wall 14 and an upright inner wall 38 of the covering hood 12; the hood portion 37 and an inner wall 38 constitute an inflow channel 39—FIGS. 1 and 3.

The crankshaft 19, or the flywheel 24, serves to drive the fan 18, which crankshaft 19 and which flywheel 24 project beyond the upper side 5 of the internal combustion engine 2. The fan 18 and the flywheel 24 are structurally integral or, in other words, they constitute a prefabricated structural unit, for example in the manner of a module. In order to effect efficient influencing of the airflows Lges; TdL1 and TdL2, the inlet opening 15 is disposed in the first rear hood wall 14, as viewed in the direction of travel A of the vessel; the fan 18 with crankshaft 19 and flywheel 24 is adjacent to the front hood wall 14′. Owing to this arrangement, a fundamental operative region Wb—FIG. 3—is produced in the interior space 13 of the covering hood 12, between the inflow channel 39 and the fan 18. In this operative region Wb, the portion of the airflows TdL1 is routed past the surfaces OfL1 to OfL4 of the internal combustion engine 2, or of the ancillary units, at a defined pressure, caused by the fan 18, such that a selective cooling effect is produced at the said surfaces OfL1 to OfL4. For this purpose, the fan 18 is designed such that the suction pressure is approximately 2 to 3 times greater than the suction pressure of the suction system 30 of the internal combustion engine 2.

The first upper flywheel 24, with the fan 18, is covered by a first upper cylindrical hood portion 40; the second flywheel 25 is covered by a lower cylindrical hood portion 41. The upper hood portion 40 is provided with a first cover plate 42, which has an inlet opening 43 for the supply air of the fan 18. The fan 18 has a fan wheel system 44 having mixed flow, radial flow or the like. The lower hood portion 41 has a second cover plate 45, which is provided with a plurality of through-openings 46, represented as radial slots. The upper hood portion 40 and the lower hood portion 41, which encase the flywheels 24 and 25, are realized as a fan-flywheel cover 47 that is made from a single piece or composed of a plurality of parts. It comprises, for example, four fastening lugs 48, and is held in position at different points on the internal combustion engine 2 by means of screws.

The first upper cylindrical hood portion 40 for the first upper flywheel 24 that is integral with the fan 18 is provided with a third routing means 49, formed onto which there is a spiral-type tangential channel portion 50, which routes the exhaust airflows AL aspirated and conveyed by the fan 18, via an exhaust channel 51 of the tangential channel portion 50 and the outlet opening 16 in the covering hood 12, into the atmosphere, or to the outside Aus.

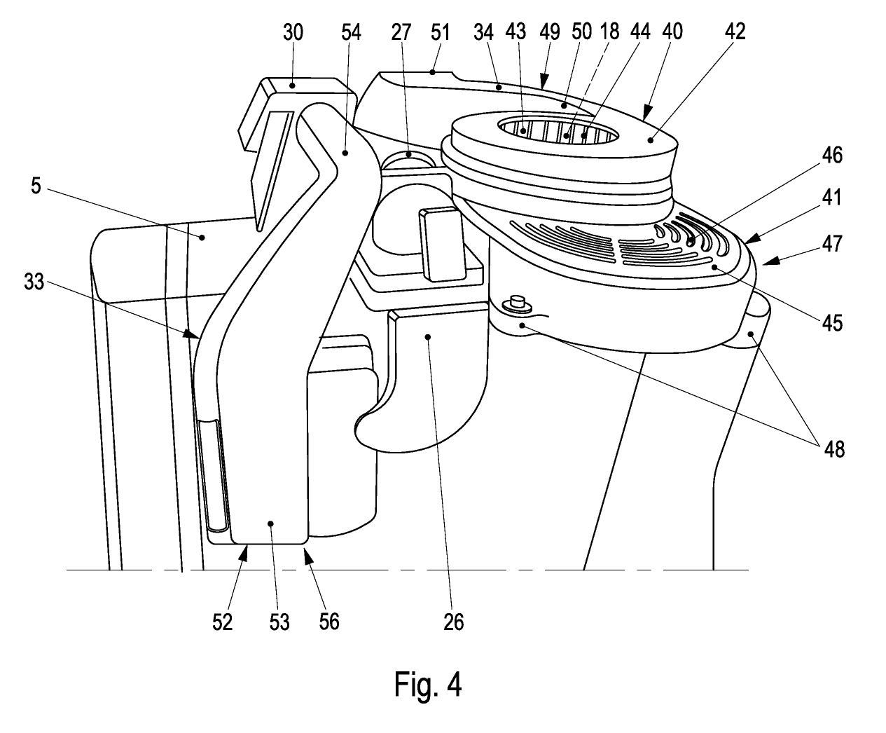

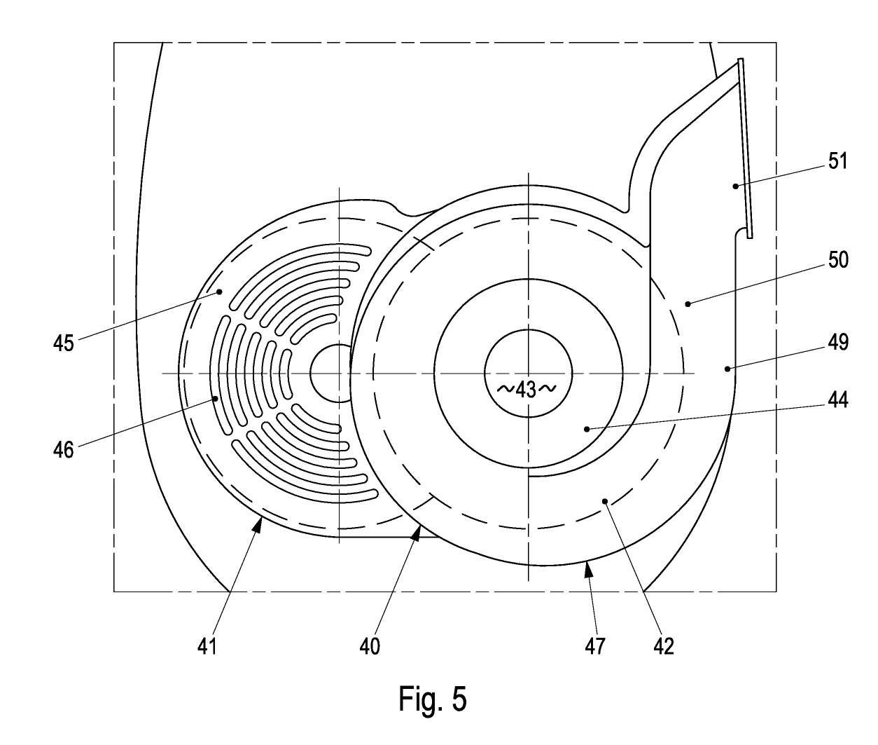

In the exemplary embodiment, the second routing means 33 toward the suction system 30 comprises a tube element 52, which has an upright tube element portion 53 and a horizontal tube element portion 54—FIG. 4. The tube element portions 53 and 54, produced from a single piece, extend at a distance from the internal combustion engine 2, and have a T-shaped configuration. The tube element 52, with the horizontal tube element portion 54, is connected to the suction system 30 by means of a connecting element 55—FIG. 7. The connecting element 55 is connected to the compressor 28 of the exhaust-gas turbocharging means 27 that is driven by the exhaust-gas turbine 29. The upright tube element portion 53 commences at an intake region 56, adjacent to the lower side 6 of the internal combustion engine 2.

The method for operation of the air guide system 31 comprises the following steps:

a.) Via an inlet opening 15 located at an upper end region Ebo of a rear hood wall 14 of the covering hood 12, the airflows Lges enter a first routing means 32, and from there are guided, by means of the said first routing means 32, in the direction of the lower side 6 and the interior space 13 of the covering hood 12.

b.) Assisted by the fan 18 that is attached to the internal combustion engine 2, adjacently to the front hood wall 14′, the air guide system 31 conveys the airflows Lges.

c.) Under the influence of the fan 18, a first portion of the airflows TdL1 is guided past surfaces OfL1 to OfL4 of the internal combustion engine 2, or ancillary units 9, 10 and 11, wherein the fan 18 aspirates the heated airflows Lsw and, by means of a third routing means 34 and an outlet opening 16 in the covering hood 12, passes them, as exhaust air AL, to the outside Aus of the covering hood, or into the atmosphere.

d.) A second portion of airflows TdL2 is supplied, as intake air, via a second routing means 33, to a suction system 30 of the internal combustion engine 2.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An internal combustion engine for an outboard motor for driving a vessel, comprising:
an air guide system that acts by way of a covering hood surrounding surfaces of the internal combustion engine and of ancillary units provided with one or more inlet and outlet openings for airflows moving in an interior space of the covering hood, and
a fan driven by way of the internal combustion engine to at least partly influence the airflows moving in the interior space of the covering hood, wherein
the airflows enter the interior space of the covering hood via an inlet opening and a first routing arrangement adjoining the latter,
the air guide system functions such that, assisted by the fan, a portion of the airflows acts on the surfaces of the internal combustion engine and of the ancillary units,
by way of a second routing arrangement, another portion of the airflows goes, as intake air, to a suction system of the internal combustion engine, and
the airflows heated by the surfaces of the internal combustion engine and the ancillary units are conveyed by the fan and a third routing arrangement, as exhaust air, via an outlet opening in the covering hood, outside of said covering hood or into the atmosphere.

2. The internal combustion engine as claimed in claim 1, wherein at least one of the inlet openings is disposed on an upright hood wall at an upper end region of the covering hood, the first routing arrangement extends in the direction of a lower side of the internal combustion engine, and the first routing arrangement has a flow-over region for the airflows toward the interior space.

3. The internal combustion engine as claimed in claim 2, wherein the first routing arrangement is constituted by a hood wall portion of the hood wall and an upright inner wall of the covering hood, and the hood wall portion and the upright inner wall form an inflow channel for the airflows.

4. The internal combustion engine as claimed in claim 2, wherein the fan is driven by an upright crankshaft projecting in an upright manner over an upper side of the internal combustion engine.

5. The internal combustion engine as claimed in claim 4, wherein, as viewed in a direction of travel of the vessel, the at least one inlet opening is disposed on the upright hood wall, and the fan is disposed on the upright crankshaft, adjacent to a front hood wall.

6. The internal combustion engine as claimed in claim 4, wherein the crankshaft is a first crankshaft that drives the fan, and further comprising a second crankshaft, parallel to the first crankshaft, that, together with the first crankshaft, constitutes a crankshaft system of the internal combustion engine, in which the first and second crankshafts are operatively connected, via two connecting rods, to at least one reciprocating piston.

7. The internal combustion engine as claimed in claim 6, wherein the crankshafts are disposed transversely in relation to a direction of travel of the vessel and have, at their upper ends that project over the upper side, first and second flywheels, which, as viewed in a vertical direction of the crankshafts, are disposed in an offset manner in relation to one other and overlap one another in regions, and the fan is structurally integral with the first flywheel.

8. The internal combustion engine as claimed in claim 7, wherein the first flywheel is an upper flywheel, with the fan, and the second flywheel is a lower flywheel, and the first and second flywheels are covered by a first, upper hood portion and a second, lower hood portion, which are realized as a fan-flywheel cover that is produced from one piece or composed of a plurality of parts.

9. The internal combustion engine as claimed in claim 8, wherein the first hood portion encases the fan and is provided with the third routing arrangement, which has a spiral-type tangential channel portion of the fan-flywheel cover, and the tangential channel portion routes the exhaust air conveyed by the fan, via the outlet opening, outside of the covering hood or into the atmosphere.

10. The internal combustion engine as claimed in claim 8, wherein the second, lower hood portion has a second horizontal cover plate having at least one through-opening in the form of at least one radial slot.

11. The internal combustion engine as claimed in claim 5, wherein the fan has a fan wheel system providing for mixed flow or radial flow.

12. The internal combustion engine as claimed in claim 1, wherein the second routing arrangement, toward the suction system of the internal combustion engine, comprises a tube element, which extends between a lower side of the internal combustion engine and the suction system located on an upper side of the internal combustion engine.

13. The internal combustion engine as claimed in claim 12, wherein the tube element of the second routing arrangement is connected by an orifice to a compressor of an exhaust-gas turbocharging means of the internal combustion engine that is connected to the suction system.

14. The internal combustion engine as claimed in claim 12, wherein an upright tube portion of the tube element commencing adjacent to the lower side of the internal combustion engine is provided with at least one inlet region.

15. The internal combustion engine as claimed in claim 9, wherein the second, lower hood portion has a second horizontal cover plate having at least one through-opening in the form of at least one radial slot.

16. The internal combustion engine as claimed in claim 2, wherein the second routing arrangement, toward the suction system of the internal combustion engine, comprises a tube element, which extends between a lower side of the internal combustion engine and the suction system located on an upper side of the internal combustion engine.

17. The internal combustion engine as claimed in claim 3, wherein the second routing arrangement, toward the suction system of the internal combustion engine, comprises a tube element, which extends between a lower side of the internal combustion engine and the suction system located on an upper side of the internal combustion engine.

18. The internal combustion engine as claimed in claim 4, wherein the second routing arrangement, toward the suction system of the internal combustion engine, comprises a tube element, which extends between a lower side of the internal combustion engine and the suction system located on an upper side of the internal combustion engine.

19. The internal combustion engine as claimed in claim 5, wherein the second routing arrangement, toward the suction system of the internal combustion engine, comprises a tube element, which extends between a lower side of the internal combustion engine and the suction system located on an upper side of the internal combustion engine.

20. A method for operating an air guide system in an interior space of a covering hood encasing an outboard motor that comprises an internal combustion engine for driving a vessel, which covering hood has inlet and outlet openings, via which airflows enter and exit from the interior space of the covering hood, wherein the internal combustion engine and ancillary units of the latter have surfaces and a suction system, and the airflows are influenced by a fan driven by the internal combustion engine, comprising:
a) via an inlet opening located at an upper end region of a rear hood wall of the covering hood, having the airflows enter a first routing means, and, from there, guiding the airflows, by way of the said first routing arrangement, in a direction of a lower side and the interior space of the covering hood,
b) assisted by the fan, which is attached to the internal combustion engine adjacently to the front hood wall, conveying the airflows with the air guide system,
c) under influence of the fan, guiding a first portion of the airflows past surfaces of the internal combustion engine or ancillary units so that the fan aspirates the heated airflows and, by way of a third routing arrangement and an outlet opening in the covering hood, passes the heated airflows, as exhaust air, outside of the covering hood or into the atmosphere, and
d) under influence of the fan, supplying a second portion of the airflows as intake air, via a second routing arrangement, to a suction system of the internal combustion engine.
